(19) United States
(12) Patent Application Publication
(10) Pub. No.: US 2009/0145841 A1
(43) Pub. Date: Jun. 11, 2009

(54) Perforated Member

(76) Inventor: Koichi Arai, Kanagawa (JP)

Correspondence Address: JAMES C. WRAY, 1493 CHAIN BRIDGE ROAD, SUITE 300, MCLEAN, VA, 22101, US

(21) Appl. No.: 12/083,113

(22) PCT Filed: Aug. 17, 2006
(86) PCT No.: PCT/JP2006/316171

§ 371 Date: Apr. 4, 2008

(30) Foreign Application Priority Data
Oct. 19, 2005 (JP) 20005-304075

(51) Int. Cl. B01D 39/14; B01D 35/30

(52) U.S. Cl. 210/497.3; 210/498

(57) ABSTRACT

The present invention provides a perforated component having the excellent hygienic property and washable structure suitable for a filter element and a jet nozzle used particularly in food processing by employing the single material such as metal, ceramic or the like. The perforated component attains the following advantages: steps for manufacturing the perforated component can be decreases; positions where foreign particles accumulate are diminished; additional reinforcements are not required; since no welding steps are included, strains, cracks and the like hardly caused by manufacturing steps. As a result the perforated component of high precision and high quality is obtained. The perforated component is formed in the following manner. Grooves 1 are formed at desired positions in a workpiece W made out of a single material. A plurality of passage holes 2 are perforated in the grooves 1. and except the grooves 2, remaining portions functioning as strength sustaining portions 3 in the workpiece are formed as a monolithic structure

### FIELD OF INVENTION

The present invention relates to a perforated component used as a filter element or a jet nozzle used in a solid-liquid, solid-solid, solid-gas separation apparatus or the like, which treats various fluid such as gas or liquid.

### RELATED BACKGROUND ARTS

Such conventional perforated components are formed, for example, in the following manners.

(1) In the case of manufacturing a three-dimensional filter element, usually a flat plate is perforated as a first step and the perforated flat plate is formed into the three-dimensional filter element. Taking workability or preciseness in perforating the flat plate into consideration, the smaller a diameter of holes to be perforated on the flat plate is require, the thinner a thickness of the flat plate is.

(2) An invention relating to a multi-layer composite filter element for series filtration is disclosed (for example in reference 1). The filter element has an inflow side and an outflow side for a medium to be filtered. The filter element comprises at least two filter layers, which are bonded together at defined points and/or surfaces over their entire surface. And at least one filter material is respectively arranged on the inflow side and on the outflow side.
Reference 1: Japanese laid open patent No. 2005-512781

### DISCLOSURE OF THE INVENTION

### Problems to be Solved by the Invention

In the case of (1), usually the three-dimensional filter element is manufactured by the following successive steps of: perforating the flat plate so as to obtain through holes thereon, forming the perforated flat plate into a cylindrical or three-dimensional workpiece, welding seams on the workpiece and welding a reinforcing member on the welded workpiece. Due to the above-mentioned mechanical steps and welding steps, strains are generated on the finished component, so that an additional step for removing such strains is required. As a result, a precision of the finished component is deteriorated and manufacturing costs are increased.

In the case of (2), the filter element is constituted by a filter fleece and a filter fabric and used in oil filters, air filters and fuel filters of automobiles and the like, so that a washability and a hygienic measure of the filter element is not considered.

The present invention is carried out in view of the above-mentioned problems in order to provide a perforated component having hygienic property and a washable structure suitable for a filter element and a jet nozzle used particularly in food processing by employing a single material, so that the following advantages are attained: steps for manufacturing the perforated component can be decreases; positions where foreign particles accumulate are diminished; additional reinforcements are not required; since no welding steps are included, strains, cracks and the like hardly caused by manufacturing steps and as a result the finished product of high precision and high quality can be obtained.

### Means to Solve the Problems

The above-mentioned problems are solved by the perforated component specified as follows.

(1) A perforated component comprising a workpiece made out of a single material, wherein: grooves are formed at desired positions in the workpiece; a plurality of passage holes are perforated in the grooves; and except the grooves, remaining portions functioning as strength sustaining portions of the workpiece are formed as a monolithic structure.
(2) The perforated component according to (1), wherein: the workpiece is formed out of a circular, rectangular, polygonal or indefinite shaped flat plate.
(3) The perforated component according to (1), wherein: the workpiece is formed out a cylindrical body having a circular, rectangular, polygonal or indefinite shaped cross-section.
(4) The perforated component according to (1), wherein: the workpiece is formed out of a cone shell, pyramid shell or polygonal pyramid shell.
(5) The perforated component according to (1), wherein: the grooves are formed in long straight grooves, discontinuous straight grooves, spiral grooves or annular grooves and have a desired cross-section such as a straight cross-section or an inclined cross-section.
(6) The perforated component according to (1), wherein: the passage holes have a circular, oval, rectangular or slit cross-section and used as a filter or a nozzle for liquid.
(7) The perforated component according to (1), wherein: the passage hole has a straight hole from its inlet opening to its outlet opening or a tapered hole from its wide inlet opening to its narrow outlet opening.
(8) The perforated component according to (1), wherein: a hardness of the surface of the perforated component is higher than the remaining other portions of the perforated component.

### EFFECTS ATTAINED BY THE INVENTION

The present invention can provide the perforated component having the excellent hygienic property and washable structure suitable for treating any fluid containing gas, solid or liquid as well as suitable for the filter element and the jet nozzle used particularly in food processing by employing the single material such as metal, ceramic or the like which can attain the following advantages: steps for manufacturing the perforated component can be decreases; positions where foreign particles accumulate are diminished; additional reinforcements are not required; since no welding steps are included, strains, cracks and the like hardly caused by manufacturing steps and as a result the finished product of high precision and high quality can be obtained.

### BRIEF DESCRIPTION OF THE DRAWINGS

FIG. 1 is views for explaining structures of a main part in embodiment 1. (a) is a plan view, (b) is a side cross-sectional view, (c) is a partially enlarged view and (d) is a cross-sectional view of a passage hole.

FIG. 2 is views for explaining structures of a main part in embodiment 2. (a) is a plan view, (b) is a side cross-sectional view, (c) is a partially enlarged view and (d) is a cross-sectional view of a passage hole.

FIG. 3 is views for explaining structures of a main part in embodiment 3. (a) is a plan view and (b) is a side cross-sectional view.

FIG. 4 (a) to (i) is views illustrating other embodiments.

### PREFERRED EMBODIMENTS BY THE PRESENT INVENTION

Hereinafter preferred embodiments of the perforated components are explained as referring to drawings.

### Embodiment 1

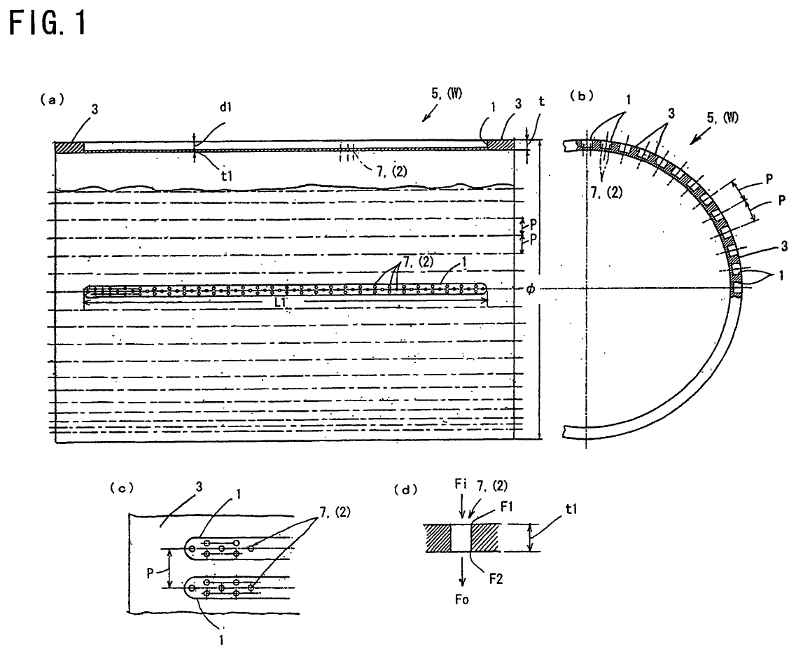

Embodiment 1 is explained as referring to FIG. 1.

FIG. 1 is views of a finished component employed in a filter element for processing liquid for foodstuffs such as vegetable juice, fruit juice and the like. Grooves 1 are formed on desired positions (in the present embodiment, it is an external surface of a cylindrical body 5) of a workpiece W (i.e. the cylindrical body 5) made of a single material. A plurality of successive passage holes 2 are perforated in the grooves. Remaining portions 3 of the workpiece W except the grooves 1 have a strength sustaining function and on the whole the workpiece is formed as a monolithic structure. A reference character p indicates a diameter of the external surface of the cylindrical body 5.

As a single material for the workpiece W, for example, a drawn tube made of various metals such as steel, stainless steel, aluminum or the like is employed. The single material is machined such that the grooves 1 are formed with a predetermined pitch p on the external surface of the cylindrical body 5 parallel to a longitudinal direction so as to form a bottom portion with a thickness t1 from the internal surface of the cylindrical body 5. The passage holes 2 are perforated in the groove so that a length of passage holes 2 corresponds to the thickness t1 of the bottom portion. As illustrated in FIG. 1 (d), the passage hole 2 is a straight hole 7 from its opening F1 to opening F2. Liquid to be treated flows through the passage hole 2 from Fi to Fo,

As illustrated in FIG. 1, the cylindrical body 5 as the workpiece W is constituted as the monolithic structured perforated component having concaves, namely the grooves 1 with a predetermined length and a depth d1. A thickness of the bottoms of the grooves 1 is t1. Remaining portions 3 except the grooves 1, namely both ends of the cylindrical body 5, portions between the neighboring grooves have a thickness t. The tubular workpiece is cut into the cylindrical body 5 with a predetermined length. The cylindrical body is machined so as to obtain the grooves having a length L1, the depth d1 and the bottom thickness t1. The straight holes 7 functioning as the passage holes 2 are perforated in the grooves by a machining process, a laser irradiating process, a forging press, applying a high pressured liquid such as water or the like.

Since positions where foreign particles accumulate are diminished by employing the perforated component as the filter element, only residues remain at predetermined positions of the filter element after passing liquid through the filter element, even if the liquid contains fruit rind or small metal pieces. The residues can be cleaned by scraping a scraper on the external surface, which is finely finished, of the cylindrical body 5.

### Embodiment 2

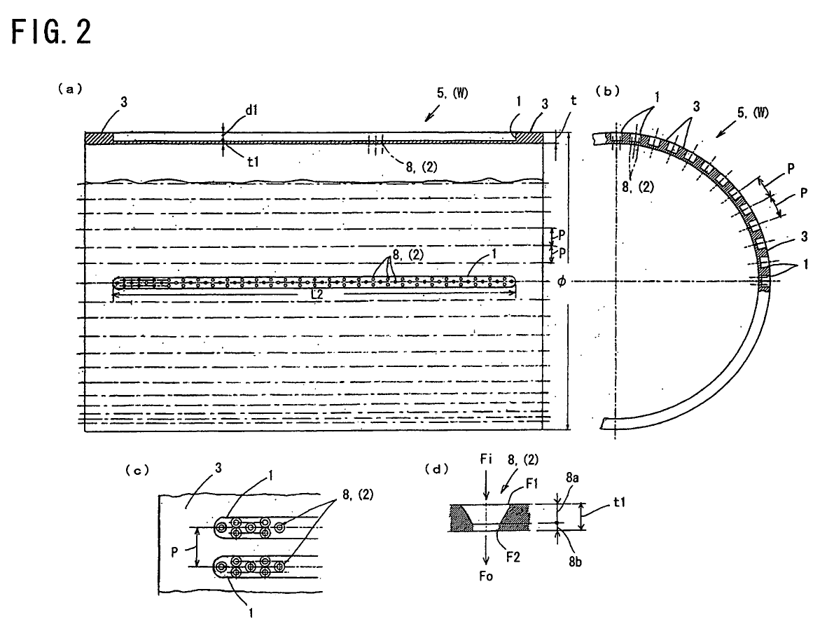

As illustrated in FIG. 2, a structure of embodiment 2 is almost the same as embodiment 1, except a shape of the passage holes 2. Here tapered holes 8 are formed as the passage holes 2, while in embodiment 1 the straight holes 7 are formed as the passage holes 2.

As illustrated in FIG. 2 (d), when liquid to be treated flows from Fi to Fo, the liquid passes a tapered channel from a wide opening F1 to a narrow opening F2. The tapered holes formed on groove bottoms with a thickness t1 are constituted by a tapered portion 8a and a straight portion 8b. A reference character L2 indicates a length of the groove 1. In FIG. 2 (d), a flowing direction is illustrated from Fi to Fo, but the flowing direction may be reversed.

A cross-sectional shape of the passage holes is not limited to those of embodiment 1 and embodiment 2, but the cross-section may be formed into a desired one such as an arc.

Since other features are the same as embodiment 1, further explanations are omitted.

### Embodiment 3

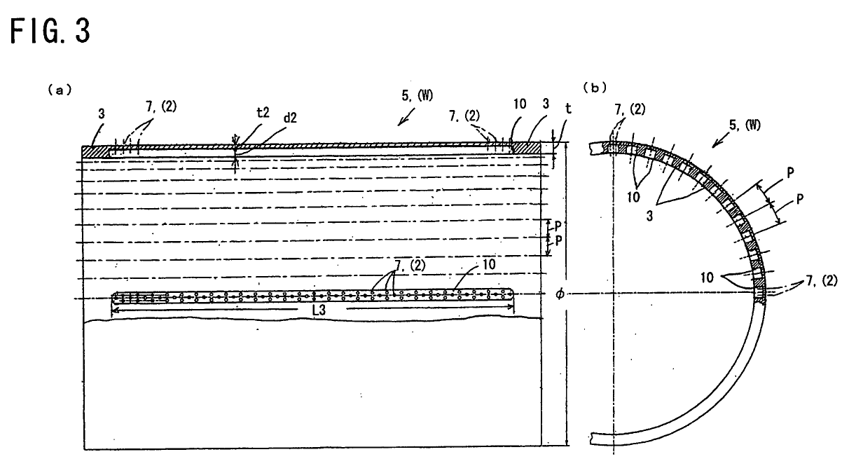

As illustrated in FIG. 3, in embodiment 3, grooves 10 are formed on the inner surface of the cylindrical body 5, while the groove 1 are formed on the external surface of the cylindrical body 5 in embodiments 1 and 2. In FIG. 3, passage holes 2 are illustrated as straight holes 7, but the passage holes may be formed as tapered holes 8.

A thickness of bottoms of the grooves 10 is t2. A depth and length of the grooves 10 are respectively d2 and L3.

### Other Embodiments

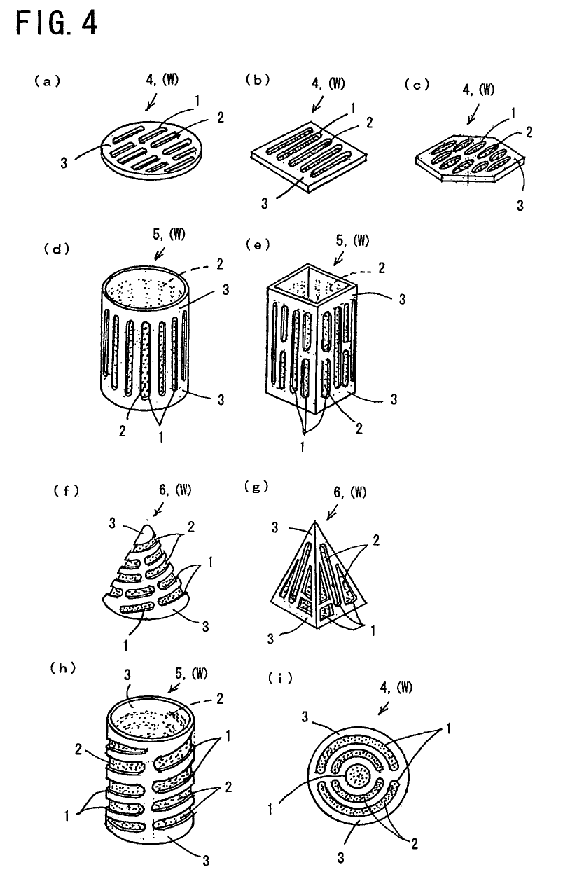

In FIG. 4, variously shaped workpieces W are illustrated.

In FIGS. 4 (a), (b) and (c), the workpieces W are illustrated as flat plates 4.

In FIG. 4 (a), grooves 1 are arranged in parallel on a circular flat plate 4 with a predetermined thickness. In FIG. 4 (b), grooves 1 are arranged in parallel on a rectangular flat plate 4 with a predetermined thickness. In FIG. 4 (c), oval grooves 1 are arranged in parallel on a hexagonal flat plate 4 with a predetermined thickness. In these drawings, a reference character 2 indicates passage holes and a reference character 3 indicates strength sustaining portions.

In FIGS. 4 (d) and (e), the workpieces W are illustrated as cylindrical bodies 5. In FIG. 4 (d), grooves 1 are arranged in parallel in a longitudinal direction on a circular cylindrical body 5 with a predetermined thickness. In FIG. 4 (e), long and short grooves 1 are arranged in parallel in a longitudinal direction on a square cylindrical body 5 with a predetermined thickness.

In FIGS. 4 (f) and (g), the workpieces W are respectively illustrated as a cone shell 6 and a pyramid shell 6. In FIG. 4 (f), discontinuous spiral grooves 1 are arranged on the cone shell 6. In FIG. 4 (g), long, triangle and rectangular grooves 1 are arranged on the pyramid shell 6.

In FIG. 4 (h), discontinuous spiral grooves 1 are arranged on the surface of the cylindrical body 5.

In FIG. 4 (i), discontinuous arc grooves 1 concentrically are arranged on the circular flat plate 4 with a predetermined thickness and a circular groove 1 is formed at the center of the circular flat plate 4. In FIG. 4, grooves 1 are arranged on the external surfaces, but the grooves 1 may be formed on the internal or rear surfaces. Since other reference numerals in FIG. 4 indicate the same portions, further explanations are omitted.

In the perforated component employed in filters and nozzles for food processing or fluid treatment, slits may be formed in place of the passage holes on the grooves.

Shapes of the grooves are not limited to those of the above-mentioned embodiments, but linear, meander, zigzag, spiral grooves and so forth may be freely employed as far as desired requirements are fulfilled, and at the same time desired shapes such as straight, inclined and the like may be formed as cross-sectional shapes of the grooves.

Desired machining method such as forging, casting, cutting, milling, electric discharging may be employed.

Particularly in the case of a metal workpiece is selected, a heat treatment, a chemical treatment or the like is easily utilized if a heightened surface hardness of the metal is required. For example, when a finished component formed out of a stainless steel workpiece W is placed in a furnace having a nitrogen gas atmosphere therein, nitride chromium layers are partially formed on the surface of the finished component, so that nitrided portions are strengthened.

What is claimed is:

1. A perforated component comprising a workpiece made out of a single material having a uniform thickness, wherein:
a plurality of grooves having a predetermined depth and a bottom thickness are formed in parallel at desired positions in said workpiece so as to keep the following relation, (a thickness of the workpiece)=(the depth of the groove)+(the bottom thickness of the groove);
a plurality of passage holes are perforated in said grooves; and
except said grooves, remaining portions having a uniform thickness functioning as strength sustaining portions of said workpiece are formed as a monolithic structure.

2. The perforated component according to claim 1, wherein:
said workpiece is formed out of a circular, rectangular, polygonal or indefinite shaped flat plate.

3. The perforated component according to claim 1 wherein:
said workpiece is formed out a cylindrical body having a circular, rectangular, polygonal or indefinite shaped cross-section.

4. The perforated component according to claim 1, wherein:
said workpiece is formed out of a cone shell, pyramid shell or polygonal pyramid shell.

5. The perforated component according to claim 1, wherein:
said grooves are formed in long straight grooves, discontinuous straight grooves, spiral grooves or annular grooves and have a desired cross-section such as a straight cross-section or an inclined cross-section.

6. The perforated component according to claim 1, wherein:
said passage holes have a circular, oval, rectangular or slit cross-section and used as a filter or a nozzle for liquid.

7. The perforated component according to claim 1, wherein:
said passage hole has a straight hole from its inlet opening to its outlet opening or a tapered hole from its wide inlet opening to its narrow outlet opening.

8. The perforated component according to claim 1, wherein:
a hardness of the surface of said perforated component is higher than the remaining other portions of said perforated component.
